(19) United States
(12) Patent Application Publication
(10) Pub. No.: US 2008/0222167 A1
(43) Pub. Date: Sep. 11, 2008

(54) SUBMISSION SYSTEM AND METHOD

(75) Inventors: Russell S. Hinds, Austin, TX (US); Michael J. Munson, Cupertino, CA (US); Burt Cummings, Menlo Park, CA (US); Mark Brown, Ben Lomond, CA (US); Pia Welch, Santa Clara, CA (US)

Correspondence Address: DAVIS WRIGHT TREMAINE, LLP/Seattle, 1201 Third Avenue, Suite 2200, SEATTLE, WA, 98101-3045, US

(73) Assignee: Sponsorwise

(21) Appl. No.: 11/855,097

(22) Filed: Sep. 13, 2007

Related U.S. Application Data
(60) Provisional application No. 60/825,568, filed on Sep. 13, 2006.
(60) Provisional application No. 60/825,566, filed on Sep. 13, 2006.

(51) Int. Cl. G06F 17/30

(52) U.S. Cl. 707/100; 707/E17.001

(57) ABSTRACT

A submission data system is used by various organizations each to receive, process, and use information originating outside of the organization. The submission system includes a submission center and various stations communicatively linked thereto. The stations are used by administrators, submitters, and post-submission users to communicate with the submission center. The submission center further includes a submission data structure generator that generates submission data structures tailored to the particular information and presentation requirements of the various organizations.

### CROSS-REFERENCE TO RELATED APPLICATIONS

This application claims priority to U.S. provisional patent application Nos. 60/825,568 and 60/825,566, both of which were filed on Sep. 13, 2006.

### BACKGROUND OF THE INVENTION

1. Field of the Invention

The present invention is directed generally to electronic data and communication systems.

2. Description of the Related Art

Electronic data and communication systems are used by organizations to receive information contained in submissions from individuals outside of the organization. Some conventional electronic data and communication systems, such as e-mail systems are relatively quick and inexpensive to implement. Unfortunately, these types of conventional systems do not impose much structure upon the content of information submitted to the organizations so the information tends not to be as useful as it might otherwise be. Other conventional electronic data and communication systems do impose greater structure regarding the information contained within the submissions, however, these systems tend to be expensive and time consuming to implement.

Much of the communication between entities such as organizations and individuals including businesses, non-profit organizations, etc includes requests of various types and responses to those requests. The communication can come in the form of email, regular mail, a phone call, an SMS text message, wireless alerts, voice mail, verbal dialog or correspondence between persons and many other forms of communication. For example the Vice President of Marketing, and/or his department in a business may receive thousands of requests for sponsorship, from events, or properties seeking a donation or wishing to offer an event sponsorship opportunity. These requests may come in all of the various forms described above, and originate from many different parties, in different formats, targeted at different destinations within the business. Unfortunately, challenges exist in managing this flow of communication and responding to it in a timely, efficient manner.

Other examples of the challenging flow of requester-provider communication are: customer complaints received by corporations, or individual stores, customer support requests, information requests, unsolicited requests, such as resumes from job seekers, or vendors seeking to provide services, or inventors seeking to encourage a corporation to devote resources to developing their invention.

In many cases companies wish to have a record of past communications and requests, and show compliance in the way the communication was handled, and that the communication was proper and appropriate. To address this need, the party receiving the communication should be able to direct parties to the appropriate point of entry (or virtual mail box), and submit the communication in a format that is customized according to the recipient, so that for example compliance with certain requirements can be proven.

Additionally it can be desirable to keep the various parties informed, including the party initially generating the communication, the party receiving the communication and other parties which may need to evaluate, process or efficiently search through various communications. For example in the case of a marketing agency seeking to help a client profitably spend marketing funds, there may be a need to search a database: of appropriate communications received, that is, requests received from properties seeking sponsorship.

Challenges exist for people, entities or parties to manage the vast number of requests and various forms of communication efficiently.

### BRIEF DESCRIPTION OF THE SEVERAL VIEWS OF THE DRAWING(S)

FIG. 1 depicts a hardware architecture of an implementation of a submission system according to aspects of the present invention.

FIG. 2 depicts the software architecture of an implementation of the submission system.

FIG. 3 is a schematic block diagram of a computer and associated equipment that is used with implementations of the submission system.

FIG. 4 is a schematic diagram of another implementation of the submission system according to aspects of the present invention.

FIG. 5 is a schematic diagram showing detail of a submission center of the submission system of FIG. 1.

FIG. 6 is a schematic diagram of a submission data structure of the submission center of FIG. 2.

FIG. 7 is a flowchart of a method to generate the submission data structure of FIG. 3.

FIG. 8 is an interaction diagram showing use of the submission system of FIG. 1.

FIG. 9 sketches the interactions between an administrator and an implementation of the system.

FIGS. 10 is a screen shot view of a welcome page portion of the implementation.

FIG. 11 is a diagram of the interactions between a requester and an implementation of the system.

FIG. 11A is a continuation of the diagram of FIG. 11 showing interactions between a requester and one implementation of the system.

FIG. 12 is a screen used to gather information from a requester who is registering.

FIG. 13 is a view of a screen employed by a requester to indicate the type of requests being made.

FIG. 14 is a view of a “templates” screen which is used to define or edit provider-defined request types.

FIGS. 15-17 are views of the screens that a requester uses to supply information pertaining to a request.

FIG. 18 is a view of a “destination” screen used by the requester to determine the best place in the provider organization to submit a request.

FIG. 19 is view of a screen that enables a requester to provide mailbox-specific information to a provider, to include a cover letter, and optionally to include a file as an attachment.

FIG. 20 is a view of a confirmation screen showing that a proposal has been successfully submitted.

FIG. 21 is a diagram of interactions between a mailbox manager and an implementation of the system.

FIG. 22 is a view of a screen displaying a submission review page used by the provider to review received requests.

FIGS. 23-25 are views of screens that are displayed from the profile detail page displaying information contained in a request.

FIG. 26 is a view of a screen that permits an advanced search.

### DETAILED DESCRIPTION OF THE INVENTION

As will be discussed in greater detail herein, a submission data system is used by various organizations each to receive, process, and use information originating outside of the organization in an efficient and effective manner. The submission system includes a submission center and various stations communicatively linked thereto. The stations are used by administrators, submitters, and post-submission users to communicate with the submission center. In a broad sense, an organization is a social arrangement of individuals, which pursues collective goals, which controls its own performance, and which has a boundary separating it from its environment. Regarding the system, at least one of the individuals of any one of a group of organizations and typically more than one of the individuals of any one of the group of organizations is a user of the system by access to a networked computer station. In the social sciences, organizations are studied by researchers from several disciplines, the most common of which are sociology, economics, business, political science, psychology, management, and, and organizational communication. In other applications of the submission system, an individual user may serve as an organization.

The system allows for flexibility in addressing the information intake requirements of multiple organizations without burdening these organizations with development delays and expenses associated with conventional customization approaches. Each organization has a data structure found in the submission center to store and control use and administration of information received from submitters. Submission of information by the submitters is structured by the submission center through use of created tags, and pre-built forms or dynamically built templates and other intake forms . On the other hand, the submission center provides automated assistance in generating and organizing varied sets of the intake forms for organizations having a wide range of requirements to receive varied information from the submitters.

During a submission of information, a submitter will respond to various request fields presented in webpages and other screens from the submission center. The requests are generally found on one or more webpages or other screens and can take the form of fields such as free-form text, check boxes, or other input types found with electronic intake forms. In response to these requests, information is transmitted to the submission center from stations used by the submitters in the form of electronic alpha-numeric characters or other sorts of responses from input devices of the stations such as keyboards, trackballs, mice, pointers, text messaging, etc.

The submission center provides an automated process to assist an administrator in setting up or modifying one or more customized intake forms for an organization to help reduce development time and expenses typically experienced with conventional systems. The automated process can receive detail from the administrator such as number of questions to ask a submitter, type of submission involved (such as donation, charity, education, etc), and branding details to specify appearance of information request screens to be presented to the submitter. The administrator can also indicate detail regarding, access privileges involved with the submitted information once stored, and details regarding any responses such as a message or document to be sent to the submitter or how such responses may be triggered such as by passage of time and/or particular information about or given by the submitter.

The one or more customized intake forms sent from the submission center to the submitter station can contain information request fields and can have an appearance and style that can be tailored to the particular organization so associated such as related to the appearance of a website of the organization.

Once information is inputted into the submission center to be contained in a submission data structure, the information can be searched upon and annotated by those with access privileges. Messages can be generated manually or automatically to be sent within or outside of the submission center based upon various conditions associated with the information such as a particular response to a request field, a particular trait of the associated submitter, at what time or at what location the information was submitted, etc. Some of these messages can be sent outside the submission center can be sent to e-mail systems. Other of these messages can be sent within the submission center to be stored in the submission center in electronic mailboxes to be accessed by the recipient by logging into the submission center. These messages can contain comments about the information and/or attached documents such as vouchers or coupons to be used in commerce or other activities.

The information can relate to such things as educational grants, donations, specialized compliance questions, sponsorship processing, multiple languages, overstocked supplies such as groceries, give away programs, tracking various events or entities such as patentable concepts, liability issues, evidence of original submission date and terms, free and earned gifts, etc. Since these examples are only representative, the information could be related to other topics as well.

Exemplary implementations of the system are employed by specific sponsors or agencies to manage the submission of proposals from organizations that operate events, or properties seeking a donation or wishing to offer an event sponsorship opportunity. These requests may originate from many different parties, in different formats, targeted at different destinations within the sponsoring organization. The requester may be referred to as a submitter, a property owner, a retailer, an individual with an idea or an individual providing feedback. In this implementation, the provider may be referred to as a sponsor, client, agency, or simply a company or organization.

The method and implementation allows for multiple requesters and providers to communicate. It incorporates an online submission system that is accessible via a computer network such as the Internet, so that no software needs to be installed at the site of a business or individual employing the system. Requesters can submit their requests to a provider by accessing a web page that is part of the system but can be branded with the identity of the provider.

Such a system may also be used to conduct searches, report and export the results, and save search results.

Aspects of this method and implementation permit a provider to
Direct submitters to an online submission system
Screen proposals automatically
Sort and filter proposals according to their marketing criteria with optional auto response capabilities
Create a searchable database of submissions
Access a database of proposals to multiple businesses
Facilitate sharing information across small or large groups internally or with their advertising agency
Control reconfiguring or changing information presented to those submitting requests
Access the information at any time
Have the ability to create the same look and feel of the business's own website.
Increase customer satisfaction by providing submitters the appropriate tools to get their job done.

In the implementations of the methods and apparatus discussed here, requests can be of many sorts, including proposals for funding, sponsorship, or grants, customer complaints, customer support requests, information requests, resumes from job seekers, offers from vendors to provide services, disclosures from inventors seeking support to develop their invention, suggestions, complaints, requests to use trademarks, product donations, requests for team or team-member appearances, requests for speakers, requests to represent or carry product lines, promotional ideas, or other unsolicited requests. Requesters can thus include organizations that operate events, non-profit agencies, government-funded researchers, grant applicants, customers, consumers in the marketplace, job seekers, vendors, inventors, venues (such as stadiums, theaters, racetracks), athletes, sports teams, entertainers, traveling shows, expeditions, or individuals.

In various implementations, providers can include businesses, sponsors, advertising agencies, government agencies, athletic teams or organizations.

In contrast to traditional email or other forms of communication, a system based on the method and implementation tags the communications with metadata, in standard formats, that included information derived from questions and responses directed to the communicator. Based on this metadata, the initial communicator is directed to a specified entry point in the system, such as a virtual mail box, to enter data and answer questions about the communication or request. In this way the communication is tagged in a manner that allows future processing, filtering, redirection and analysis of the communication. The metadata gathered for each type of communication can be specified by a combination of system defaults and by users.

Although the Internet is the preferred data transport mechanism for such systems, they may interact with users using any public or private computer network

In one implementation, a website available to users via the Internet provides a comprehensive source of information about events, event managers and event sponsors. Users who visit this website, Sponsorwise.com® are able to browse a database which serves as a multiple listing service for the sponsorship industry. The website also includes a search facility for retrieving specific information.

Versions of the system provide its users with a standardized executive summary format that is quick and easy to review. It supports multiple ‘mailboxes’ so that proposals are delivered to the right person within the receiving organization.

Versions of the system include automated screening of, and optional declines to, request submissions, as well as the ability for a member of the receiving organization to decline a request manually with a single click of a computer mouse.

Versions of the system include a searchable archive of requests. It incorporates features that allow great flexibility in branding the site where requests to a given provider can be submitted.

Versions of the system provide for a collection of communication “types” such as specific kinds of events that could be easily modified, extended, customized and branded to meet the needs of corporate sponsors.

Versions of the system permit corporate sponsors to easily customize and manage the communication system.

Versions of the system provide a sponsorship management system that permits individual users working on behalf of a corporate sponsor to more readily specialize the system to their work processes.

Versions of the system provide support for requesters making the requests of the corporate sponsors.

Versions of the system extend a sponsorship management system's communication capability by providing access to communication devices in addition to computer display screens, including cellular and other wireless communication devices.

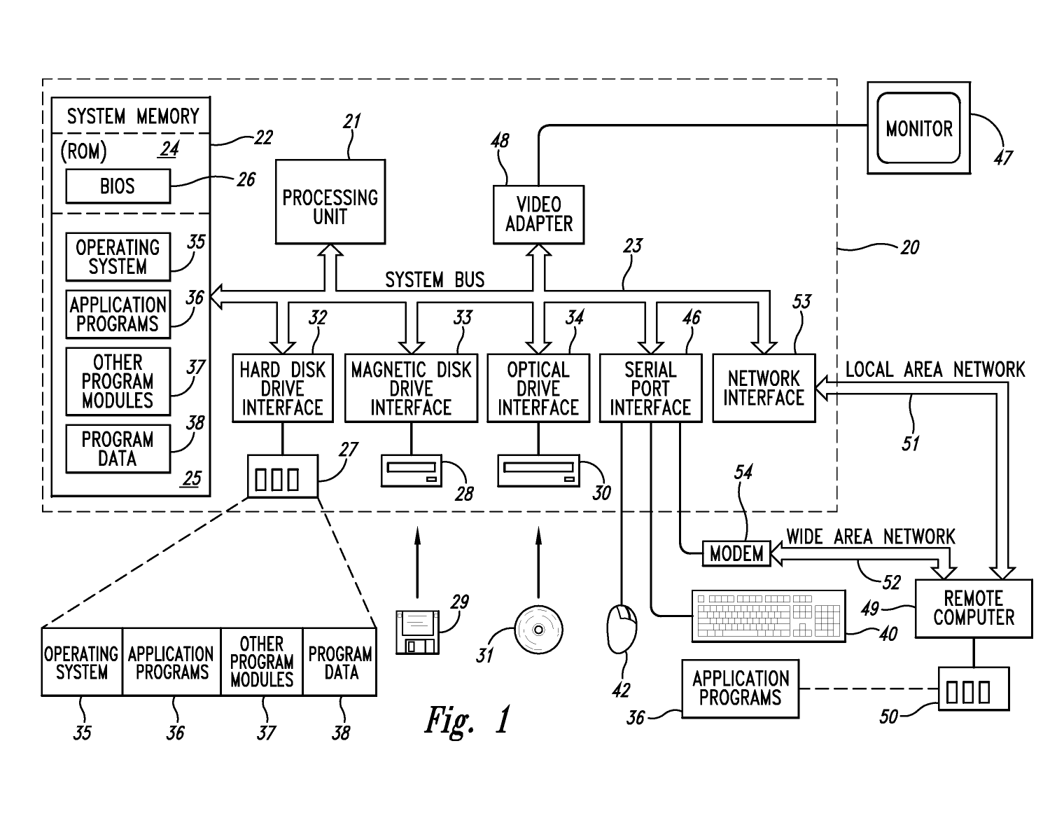

FIG. 1 is a diagram of the hardware and operating environment in conjunction with which implementations may be practiced. The description of FIG. 1 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 1 includes a general purpose computing device in the form of a computer 20, including a processing unit 21, a system memory 22, and a system bus 23 that operatively couples various system components, including the system memory 22, to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20, the local computer; implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in offices, enterprise-wide computer networks, intranets and the Internet.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

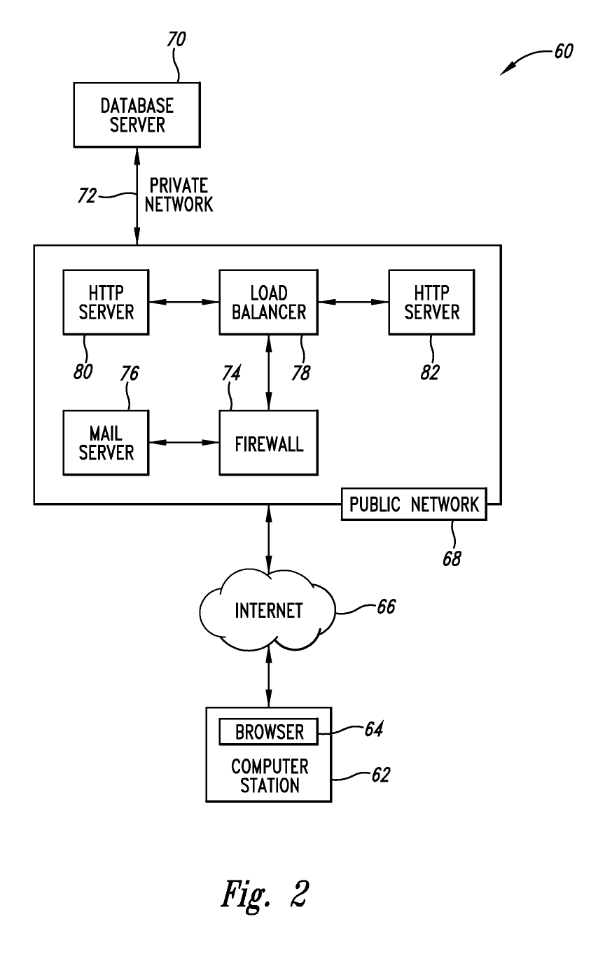

Further detail regarding an overall architecture 60 of implementations is depicted in FIG. 2 as having a computer station 62 linked to a network 66, such as the Internet, further linked to a public network 68, which is linked to a database server 70 through a private network 72. The public network 68 includes a firewall 74, a mail server 76, and a load balancer 78 distributing load between a first HTTP server 80 and a second HTTP server 82. The public network 68 includes generally the hardware components designed to store and deliver information over the Internet. The first HTTP server 80 and the second HTTP server 82 include a data storage facility (such as non-volatile memory on a disk drive), which is used to contain the non-volatile components of the software, such as a copy of the operational code of the system. The database server 70 includes a data storage facility (such as non-volatile memory on a disk drive), which is used to contain the database components of the system. The first HTTP server 80 and the second HTTP server 82 also include the operational software code of the system.

The computer station 62 as with other stations described generally includes a computer commonly known as a personal computer having hardware components such as a CPU, and RAM. The computer station 62 includes interfacing hardware enabling access to the Internet. The computer station 62 also includes a software web browser such as Microsoft Internet Explorer or Netscape Browser, or a browser of generally equivalent capability.

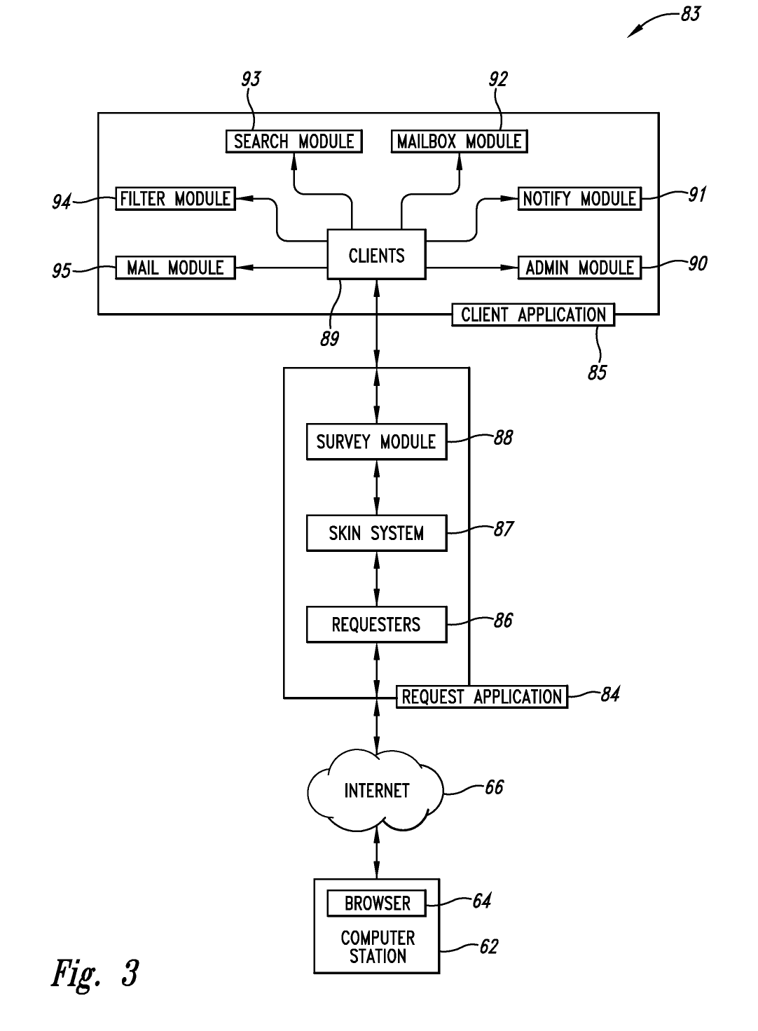

A version of software architecture 83 is shown in FIG. 3 as having a request application 84 and a client application 85. The request application 84 has requesters 86, a skin system 87, and a survey module 88. The client application 85 has clients 89 including a administration module, a notify module, a mailbox module 92, a search module 93, a filter module 94, and a mail module 95. Users, whether requesters or providers, access the requester application 84 over the Internet 66 using a web browser 64 resident on the computer station. Requesters interact with the request application 84 to submit, track, and manage their requests. Providers interact with the client application 85, which is architected so that major functions are implemented as separate modules. This modular architecture permits new capabilities to be readily added.

The hardware and operating environment in conjunction with implementations that may be practiced has been described. The computer in conjunction with implementations that may be practiced may be a conventional computer, a distributed computer, or any other type of computer. Such a computer typically includes one or more processing units as its processor, and a computer-readable medium such as a memory. The computer may also include a communications device such as a network adapter or a modem, so that it is able to communicatively couple to other computers.

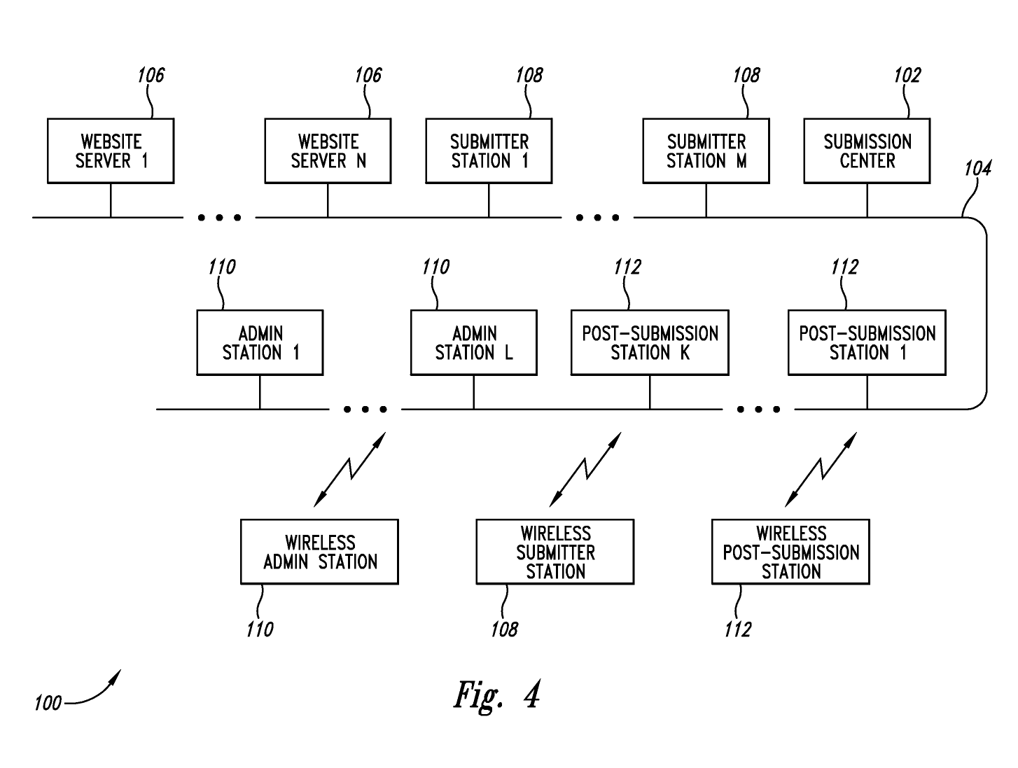

A submission system 100 is depicted in FIG. 4 as having a submission center 102 communicatively linked through a network 104 or otherwise linked wirelessly to website servers 106, submitter stations 108, administration stations 110, and post-submissions stations. The stations can be either computer workstations, mobile computers, or other devices such as mobile personal data assistants (PDA).

In some implementations a submitter uses a submitter station 108 to communicate with one of the website servers 106 to interact with one or more webpages. At some point in the interaction, the website server 106 redirects communication for the submitter station 108 to the submission center 102. Upon this redirection, access is given the submitter station 108 to one or more webpages or other types of screens originating from the submission center 102 containing intake forms hawing requests for information through use of fields, cues, prompts, or other such displayed queries.

The submitter uses the submitter station 108 to send information to the submission center 102 either by modifying the intake forms directly or otherwise in response to the requests wherein the information is stored to be processed, reviewed, and otherwise used by one or more administrators or other post-submission users depending upon their access rights. The administrators access the submission center 102 through the administrative stations 110 and the post-submission users access the submission center through the post-submission stations 112, which can be of the same or different types of hardware as used for the submitter stations 108.

An exemplary version of the submission center 102 is depicted in FIG. 5 as having engines 114, e-mail accounts 116, submission data structures 118, and a submission data structure generator 120. The e-mail accounts 116 include data storage to store messages internally generated within the submission center 102 by users of the submission center to be accessed by other users of the submission center. The submission data structures 118 contain information received by the submission center 102 from the submitter stations 108 and received from the post-submission stations 112 and are generally associated with a particular organization, website, or other entity that a group of submitters would somehow be associated with. The engines 114 can include a submission engine 122, a reporting engine 124, a response engine 126, a post-submission engine 128, and an e-mail engine 130. The submission engine 122 is used to generate the webpages or other type of screens and interfaces requesting information from submitters through use of one or more intake forms to be displayed or otherwise presented by the submitter stations 108.

The reporting engine 124 can be used to generate reports regarding information previously submitted and stored in one of the submission data structures 118. The response engine 126 is used to generate responses such as messages, letters, vouchers, coupons, and other sorts of documents to be sent to the submitter stations 108 based upon information received from the submitter station 108, submitter characteristics, or other factors. The post-submission engine 128 can be used to generate screens or other interfaces for the post-submission stations 112 regarding searches and receipt of comments furnished by authorized post-submission users regarding information stoned in the submission data structures 118

The submission data structure generator 120 provides an automated process for an administrator to use to create one of the data structures 118 that will subsequently be used to store information received by the submission center 102 from the submitter stations 108 and the post-submission stations 112 as related to a common entity such as an organization, an event, a program or other entity.

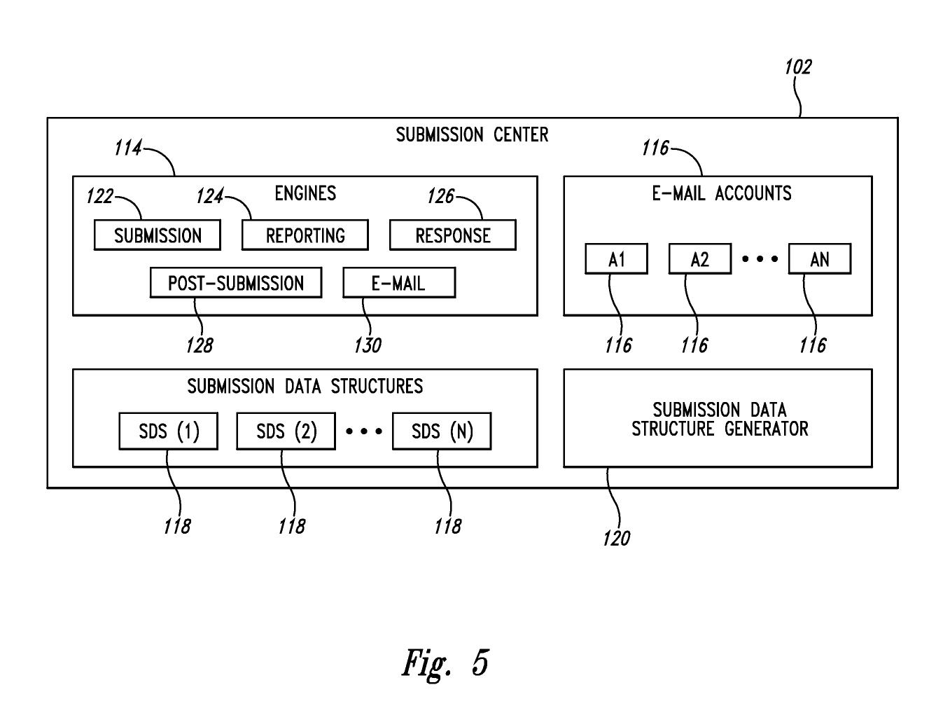

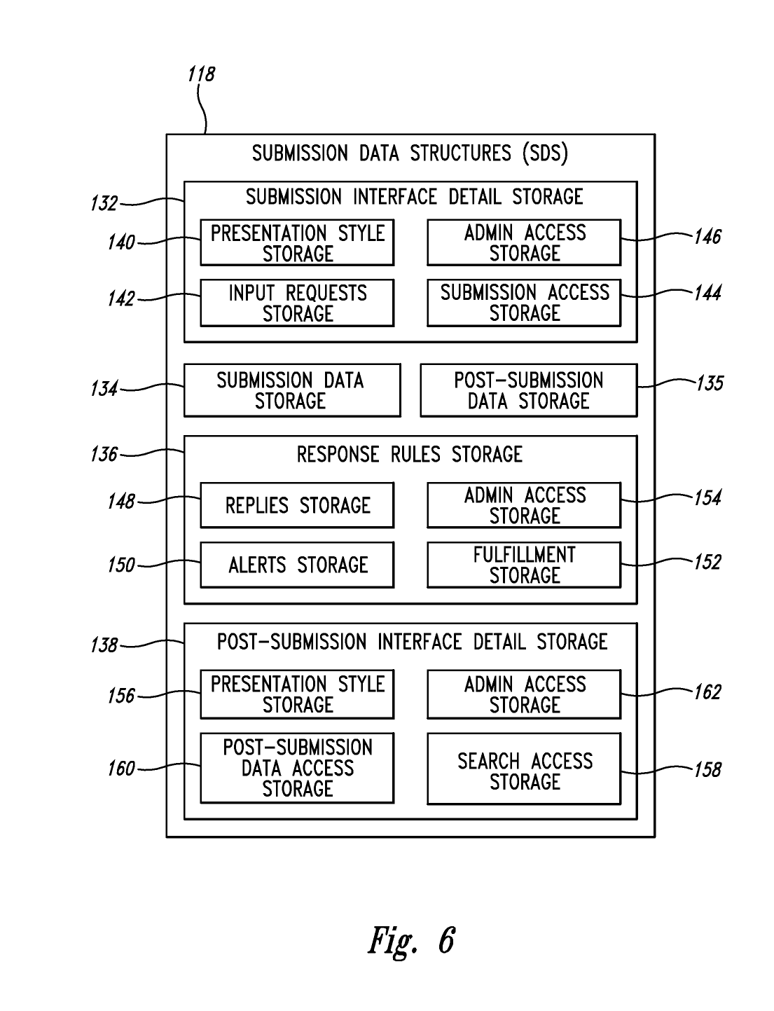

An exemplary submission data structure 102 is shown in FIG. 6 to include submission interface detail storage 132, submission data storage 134, post-submission data storage 135, response rules 136, and post-submission interface detail storage 138. Typically one of the submission data structures 102 will be used for a single organization, event, project, or other individually distinguishable entity. The submission interface detail storage 132 can include presentation style storage 140, input requests storage 142, submission access storage 144, and administration access storage 146. The presentation style storage 140 can include information as to how to display intake forms on the submitter station 108. The presentation style storage 140 can include, among other things, font information, images to display, and page placement instruction for text, images, and fields.

The input requests storage 142 can include questions and other requests of information. The input requests can also include options for responses to particular request for information such as providing a choice of a few cities for the submitter to choose from as a designation of residence address. Submission access storage 144 can contain information regarding what individuals are considered submitters for the particular submission data structure 118 to grant those individuals access to submit requested information to the submission center 102. The administration access storage 146 can contain information regarding what individuals are considered administrators for the submission interface detail storage 132 of the particular submission data structure 102 to grant those individuals access privileges to create and modify the submission data structure.

The submission data storage 134 is stored information received by the submission center 102 from the submitter stations 108 in response to requests displayed on the submitter stations based upon the input requests storage 142 found in the submission data structure 118. The post-submission data storage 135 is stored information received by the post-submission stations 112 typically as comments and other annotation about the information stored in the submission data storage 134.

The response rules 136 can include replies storage 148, alerts storage 150, fulfillment storage 152, and administration access storage 154. The replies storage 148 can include rules that govern when a response is to be sent to one of the submitter stations 108 from the submission center 102 in reply to information received from the submitter station and stored in the submission date 134 of the submission data structure 118. The alerts storage 150 can include rules as to when the submission center 102 may send out a notification to one or more of the administration stations 110 or one of the post-submission stations 112 typically based upon a particular piece of information received by the submission center from one of the submitter stations 108.

The fulfillment storage 152 can include rules as to when a document such as a voucher, e-ticket or other commercial or non-commercial paper would be sent out to one of the submitter stations 108 in response to information received by the submission center 102. The administration access storage 154 can contain information regarding what individuals are considered administrators of the response rules 136 for the particular submission data structure 118.

The post-submission interface detail storage 138 can include presentation style storage 156, search access storage 158, post-submission data access storage 160, and administration access storage 162. The presentation style storage 140 can include information as to how to display search forms, message (such as e-mail) forms, and other forms and interfaces on the post-submission stations 112. The presentation style storage 156 can include, among other things, font information, images to display, and page placement instruction for text, images, and fields. The search access storage 158 can contain information regarding what individuals are allowed to access the post-submission engine 128 through the post-submission stations 108 to conduct searches regarding the submission data storage 134 of the particular submission data structure 118. The post-submission data access storage 160 can contain information regarding what individuals are allowed to access the post-submission data storage 135 of the particular submission data structure 118 through the post-submission stations 108. The administration access storage 162 can contain information regarding what individuals are allowed to create and maintain the post-submission interface detail storage 138 access the post-submission data storage 135 of the particular submission data structure 118 through the administration stations 110.

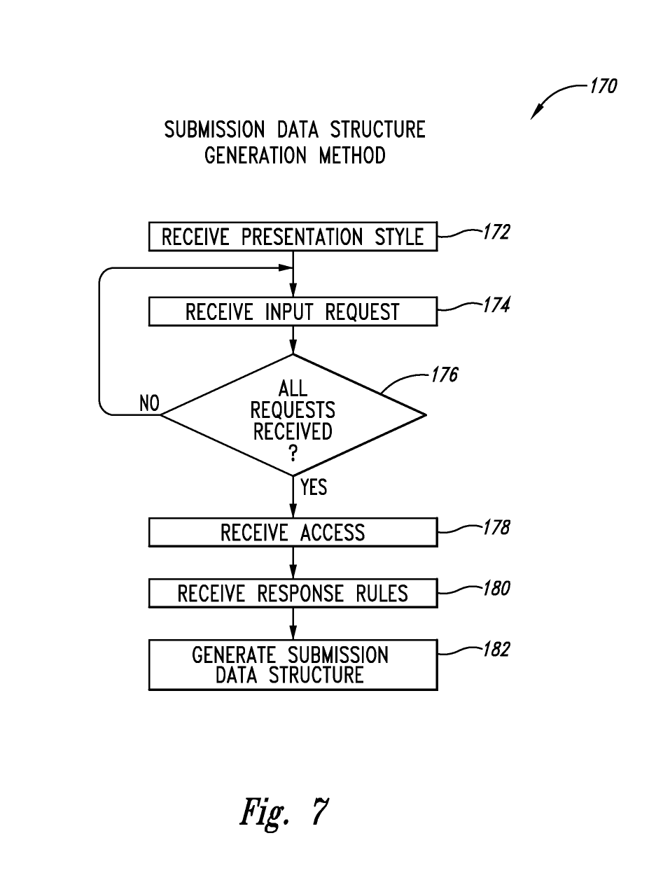

An exemplary submission data structure generation method 170, which can be used by the submission data structure generator 120 is depicted in FIG. 7 as receiving the presentation style storage 140 of the submission interface detail storage 132 (step 172). The method 170 then receives input requests (step 174) from an administrator through the administration station 110 having access privileges as indicated by administration access storage 146. The input requests from the administrator are stored in the input requests storage 142 of the appropriate submission data structure 118. The input requests are selected by the administrator to satisfy desires to obtain information from submitters through the submitter stations 108.

The method 170 prompts the administrator for additional input requests and receives an input request if the administrator has another (NO branch of condition step 176) or goes on (YES branch of condition step 176) if the administrator has no further input requests to add. The method 170a then receives information (step 178) regarding what individuals have access privileges to the submission data structure 118 regarding the submission access storage 144 and the administration access storage 146 of the submission interface detail storage 132, the administration access of the response rules storage 136, and the search access storage 158, the post-submission data access storage 160, and the administration access storage 162 of the post-submission interface detail storage 138. The method 170 then receives response rules (step 180) to be stored in response rules storage 136. Based upon reception steps above, the method 170 then proceeds to generate the submission data structure 118 (step 182).

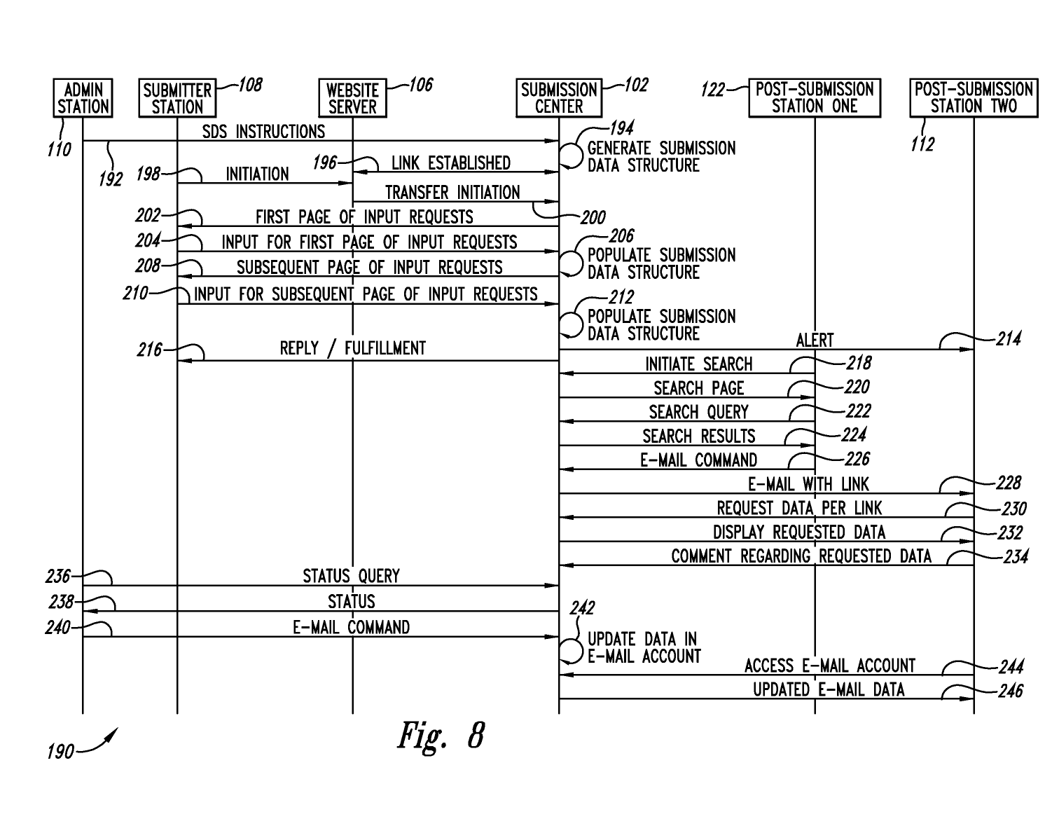

An exemplary interaction 190 is depicted in FIG. 8 in which the administration station 110 sends submission data structure instructions (action 192) to the submission center 102 according to the method 170 where the submission center generates one of the submission data structures 118 (action 194. A link is established between one of the website servers 106 and the submission center 102 (action 196). The link can be in the form of a hyper-link on the website supported by the website server 106 to the submission data structure 118 newly generated in action 194.

One of the submitter stations 108 sends an initiation (action 198) to the website server 106, which thereby transfers the initiation (action 200) to the submission center 102. The submission center 102 responds to the initiation by sending a page of input requests (action 202) to the submitter station 108. The submitter station 108 sends back input for the first page of the input requests (action 204) to the submission center 102.

The submission center 102 populates an associated one of its submission data structures 118 (action 206) and sends a subsequent page of input requests (action 208) to the submitter station 108. The submitter station 108 sends input for the subsequent page of the input requests (action 210). The submission center 102 further populates the associated submission data structure 118 (action 212). Based upon the input received from the submitter station 108, the submission center 102 sends an alert (action 214) to the post-submission station two 112 (action 214) and sends a reply or fulfillment to the submitter station 108 (action 216).

The post-submission station one 112 initiates a search (action 218) with the submission center 102. The submission center 102 returns a search page (action 220). The post-submission station one 112 completes the search page to send a search query (action 222) to the submission center 102. The submission center 102 returns search results (action 224) to the post-submission station one 112. The post-submission station one 112 sends an e-mail command to the submission center 102 (action 226). The submission center 102 sends an e-mail with a link (action 228) to the post-submission station two 112. The post-submission station two 112 sends a request or data as directed by the received link (action 230). The submission center 102 sends the requested data (action 232) to the post-submission station two 112 to be displayed. The post-submission station two 112 sends comments about the requested data to the submission center 102 (action 234).

The administration station 110 sends a status query to the submission center 102 (action 236). The submission center 102 returns a status report to the administration station 110 (action 238). The administration station 110 sends an e-mail command to the submission center 102 (action 240). The submission center 102 updates data in one of the e-mail accounts of the submission center 102 (action 242). The submission center 102 receives a request from the post-submission station two 112 to access one of the e-mail accounts on the submission center 102 (action 244). The submission center 102 sends updated e-mail data to the post-submission station two 112 (action 246).

Setup and Administration

When an account is set up for a provider, three levels of users are specified. Administrators are able to set guidelines and branding and view any mailbox. Mailbox managers may view just their mailbox and set filters and searches, and are authorized to decline proposals. Viewers can just search and review information in mailboxes.

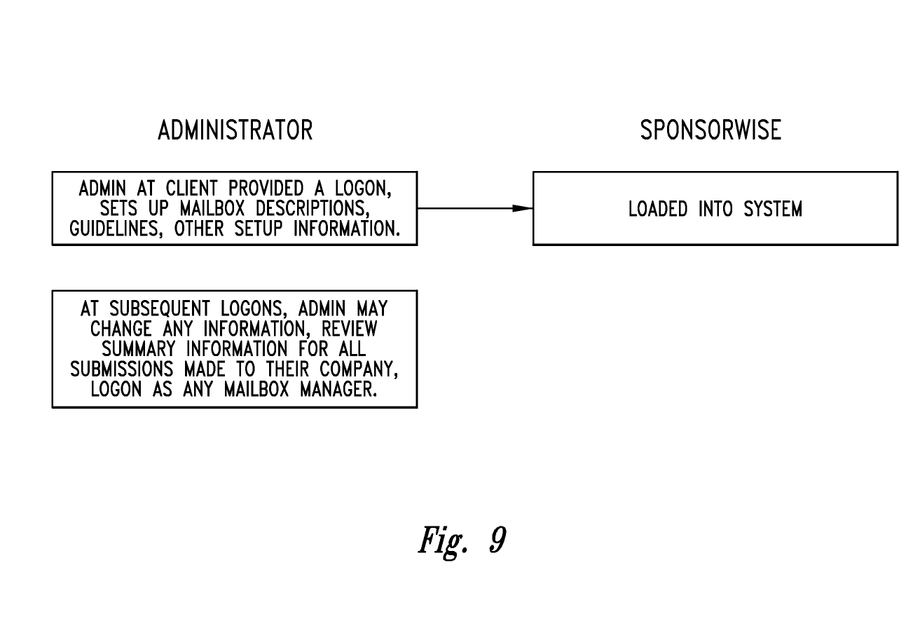

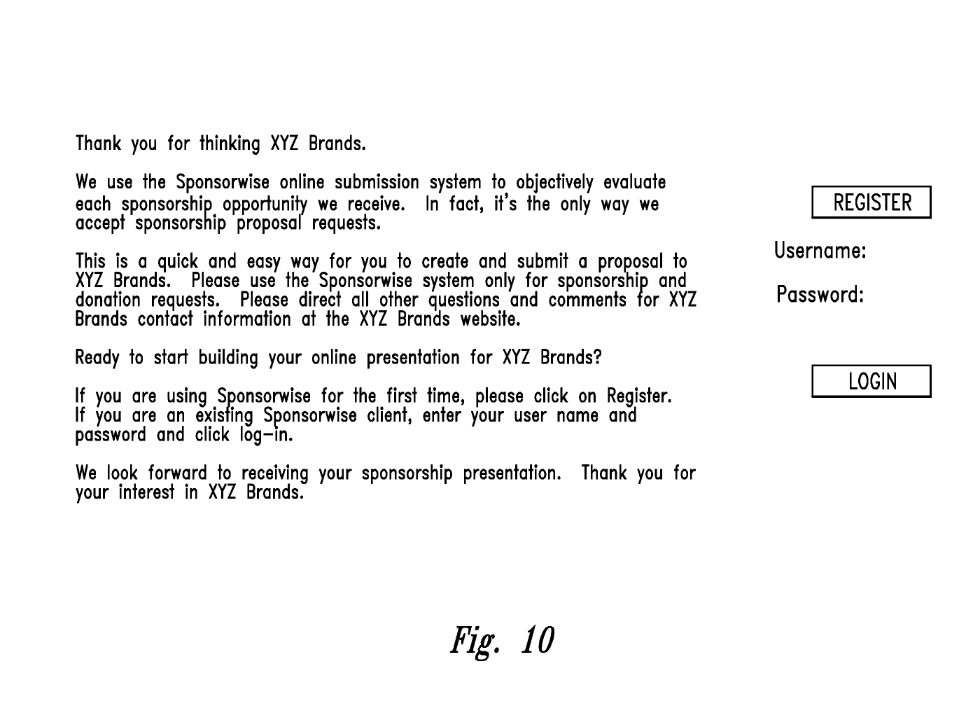

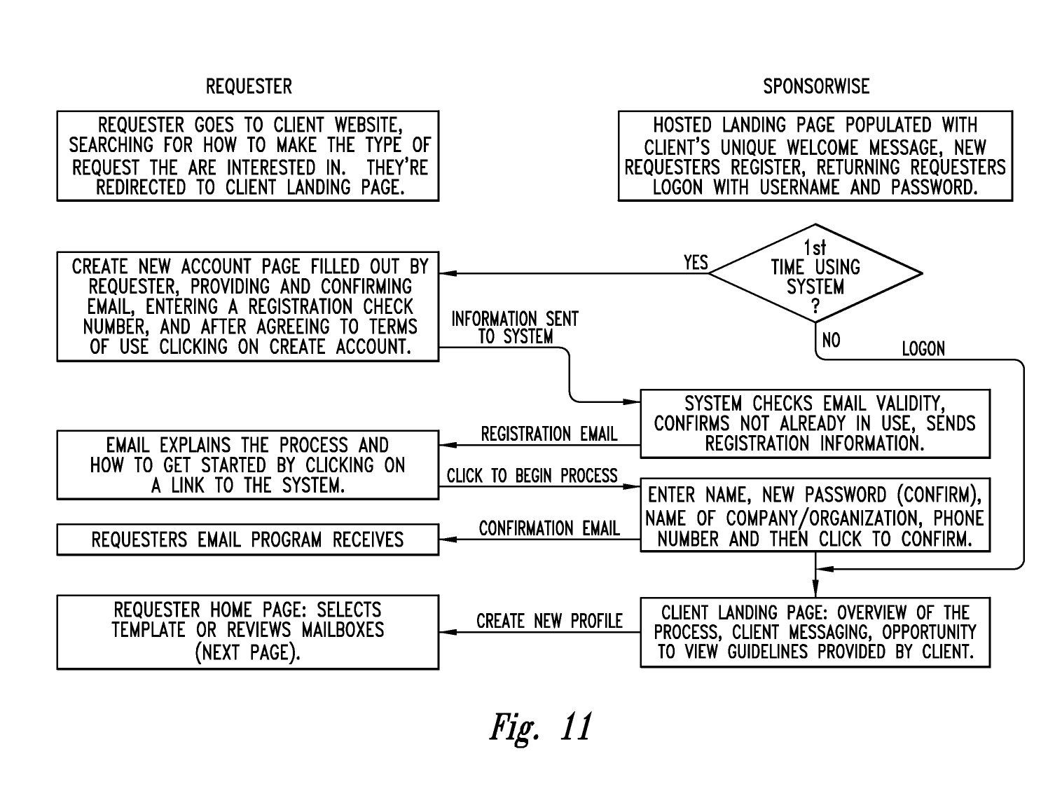

To set up to use the system, an Administrator affiliated with the provider employs the system to define initial information, as discussed in the text below and depicted in FIG. 9. The Administrator specifies information needed to define the Welcome Page, which is a provider-specific page within the system to which requesters are directed to engage the system. An example of a Welcome Page is depicted in FIG. 10. The Administrator specifies how the system is to be branded. This information is specified using a single style sheet whose information is used in composing all the user-accessible screens presented by the system, permitting rapid setup or modification.

The Administrator establishes mailboxes for the departments and individuals within its organization that will process requests as they arrive. The Administrator sets filters, which are sets of rules for each mailbox that are used to automatically determine whether a given proposal meets the requirements for consideration by the department or individual associated with that mailbox. These can be managed and changed at any time. The Administrator creates a “guideline” for each mailbox. Guidelines are text describing the function of the organization or department associated with each mailbox, describing the types of requests that the organization or department associated with each mailbox is interested in receiving, or other information directed at requesters that is specific to each mailbox. The system provides for the setup, management and change of guidelines for individual mailboxes.

The Administrator can define labels (such as “review in March”, “sponsoring”, “check with Tony”) to be used to characterize individual proposals.

The Administrator creates a “decline note” that will be used to inform requesters whose requests are declined.

The Administrator can choose whether to open the provider's database of requests to other providers, and can implement or change its choice with a single click.

These setup and administration activities are performed by interacting with a set of screens displayed via a web browser, and can be performed in a few hours.

Features Supporting Requesters

Once the system is set up, requesters can contact the provider using a variety of communications modalities such as a telephone call, email, regular mail, an SMS text message, a wireless alert, voice mail, a live dialog, an RFID reader in conjunction with an RFID chip, access through a company website or correspondence between persons and many other forms of communication, as they have done prior to installation of the system. The provider uses techniques known in the art, for example an outgoing message for a voice mailbox or messages and links on their website, to redirect the inquiries to the appropriate Welcome Page within the system.

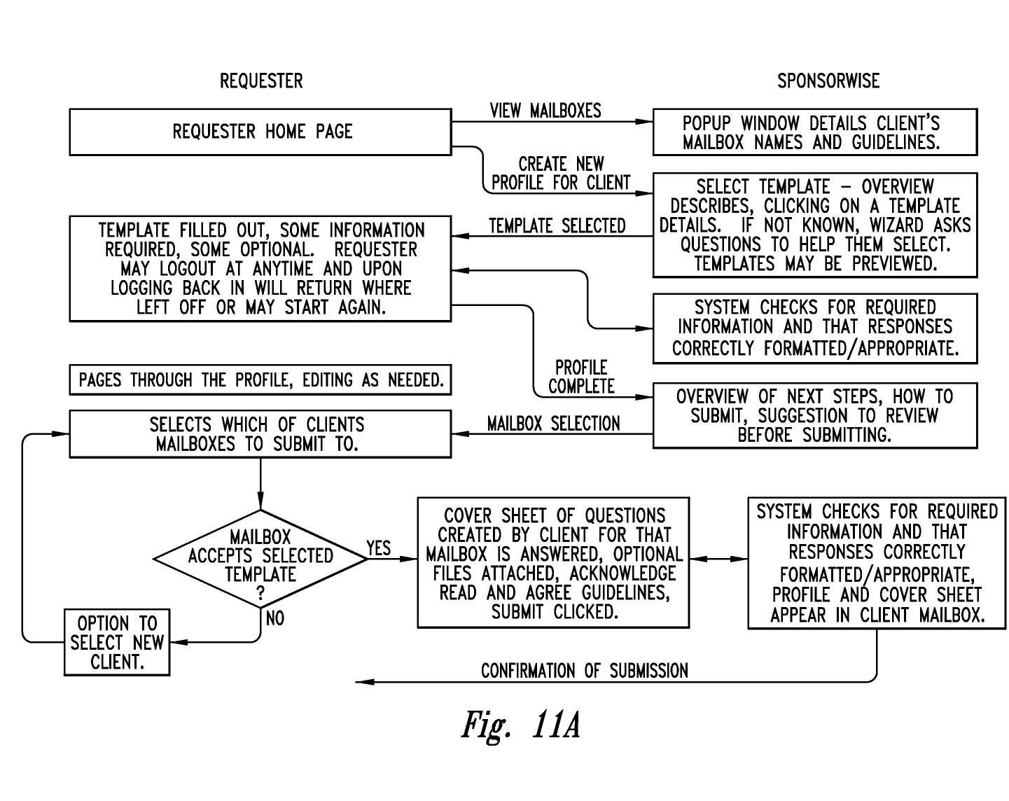

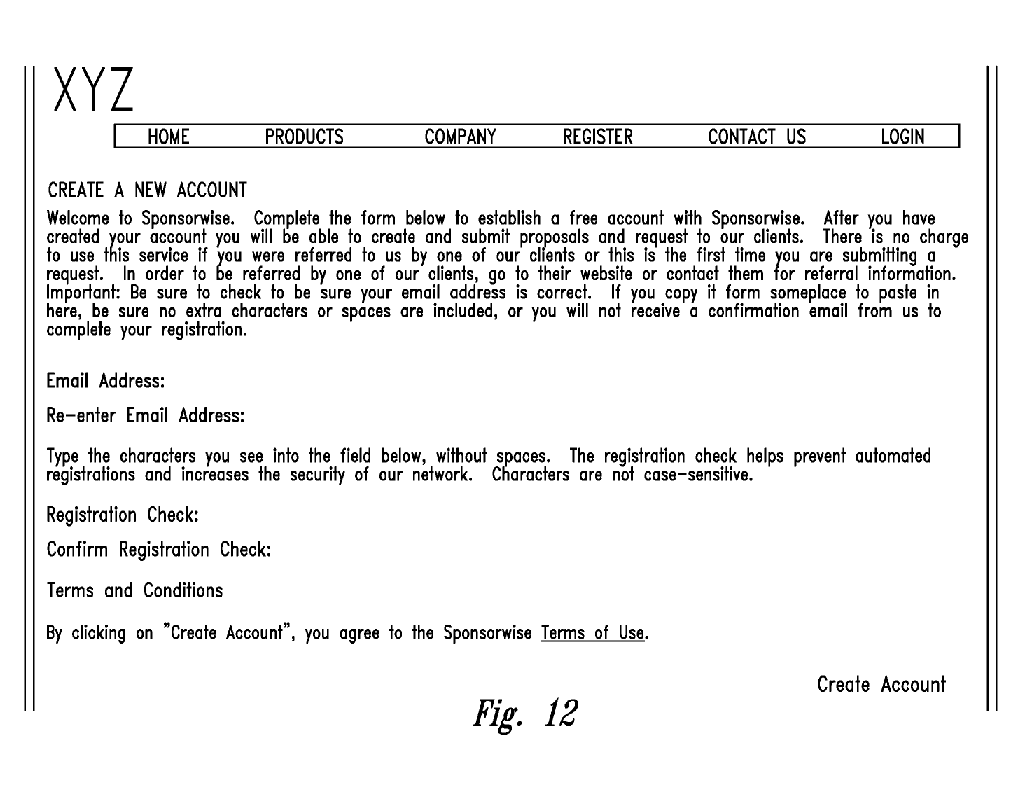

When the requester accesses the system via the Welcome Page, it guides him or her through a process of composing, transmitting, and monitoring a request, as discussed in the text below and depicted in FIG. 11. The Welcome Page displays a request that he or she log in to the system. If the user has not previously registered with the system, he or she is directed to a screen, depicted in FIG. 12, via which the user's email address is specified and an opportunity is provided to agree to the terms of service.

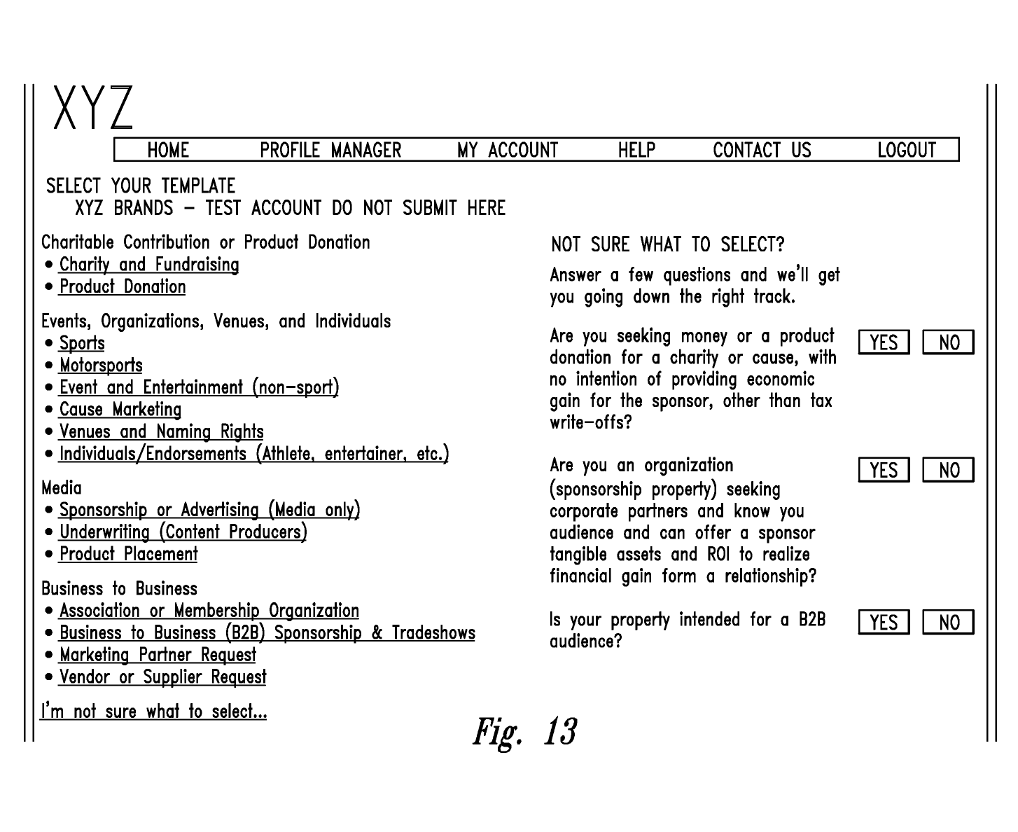

The system then assists him or her in determining the type of request (using standard terms available in the system or the terms established by the receiver during setup) that they are making. FIG. 13 shows a screen listing the request types at the left. The requester can select the appropriate type by moving the computer cursor over the correct type and left-clicking. If the requester is unsure of the appropriate type to select, the system guides him or her through a series of questions as depicted on the right of FIG. 13. The questions in this “Request Wizard” drive simple decision tree logic that leads to determining a request type.

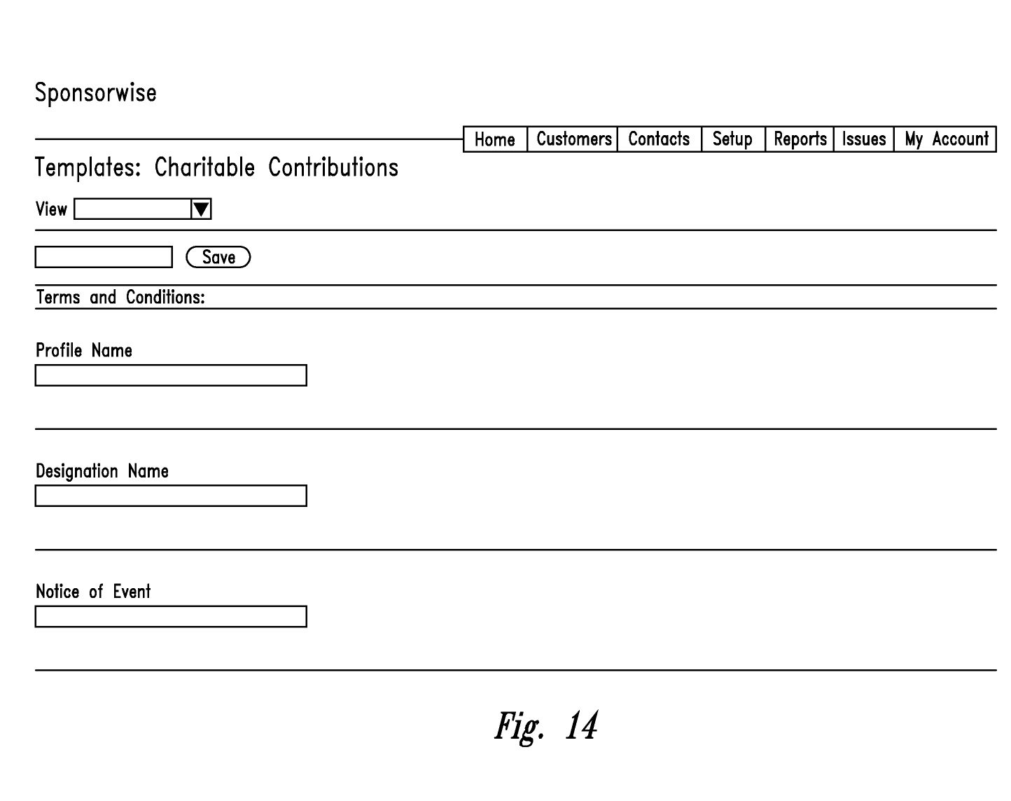

Versions of the system support a collection of request “types” that can be easily modified, extended, customized and branded by each provider to meet its needs. Request templates are implemented in such a way as to be easily edited and support quick creation of new request types. The format and text of specific questions can be changed at any time, and questions can be added or removed at any time by a Sponsorwise Administrator. These changes are immediately available to all requesters. FIG. 14 shows a “Templates” screen which is used by the provider to create or edit a request type.

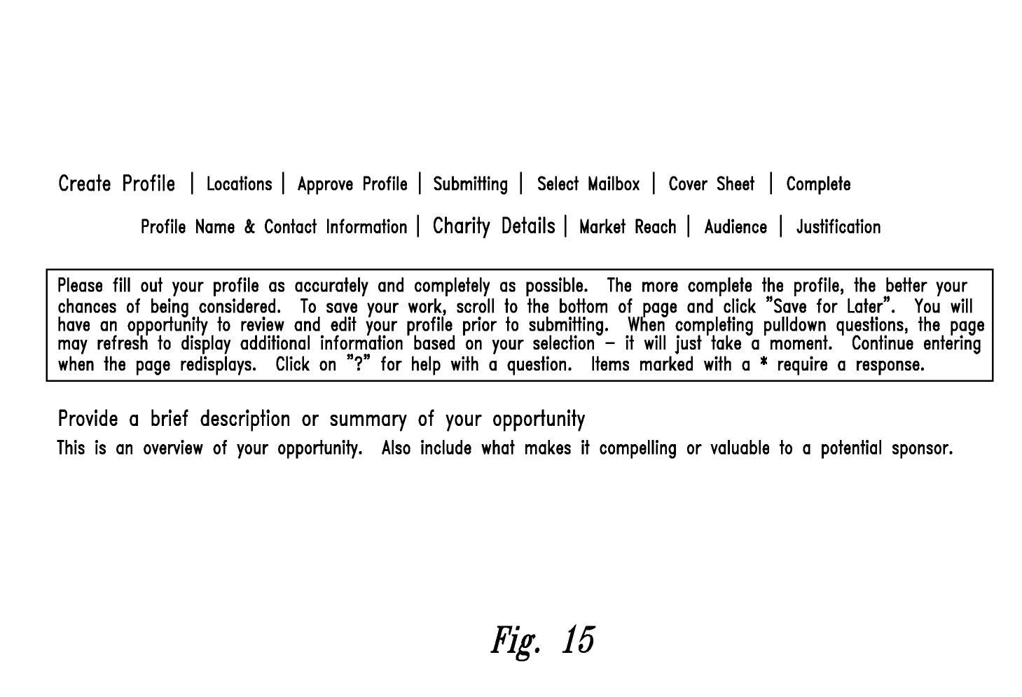

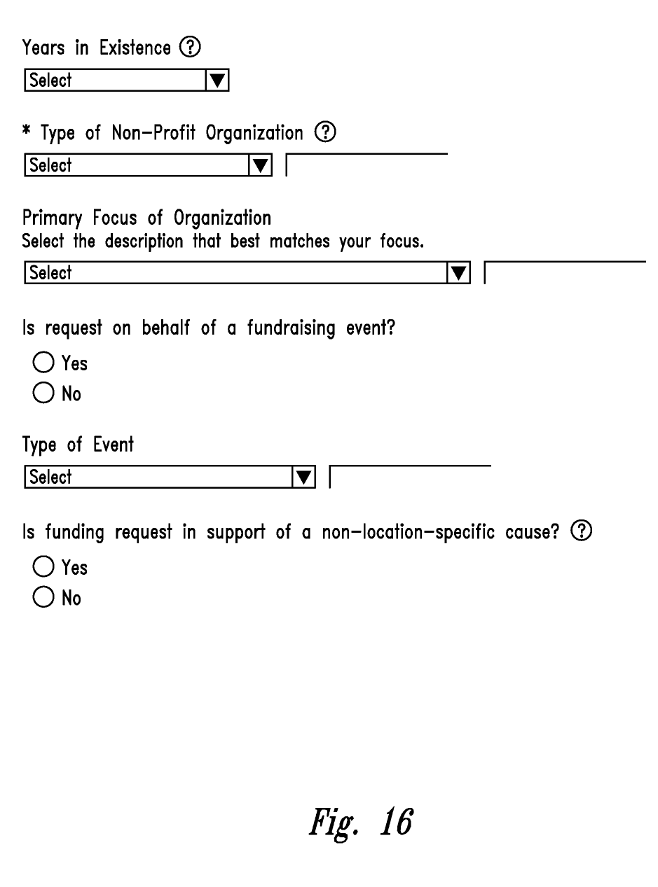

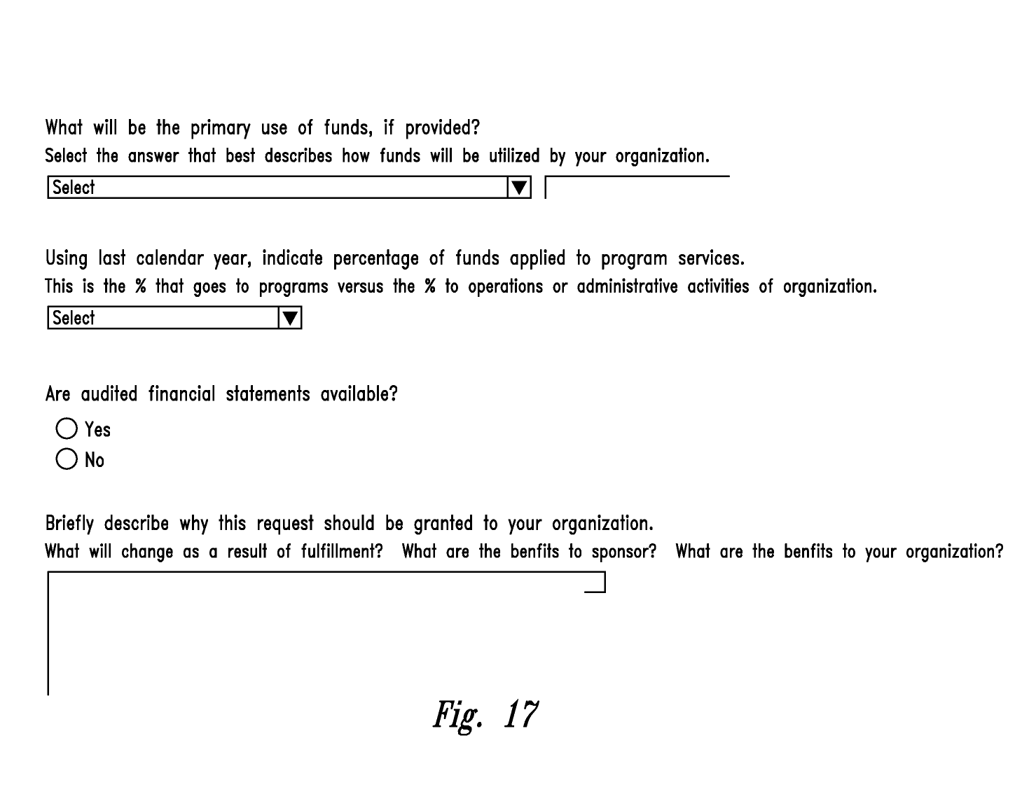

After the request type is determined, the requester employs the system to create a request using screens such as those shown in FIGS. 15-17. A progress bar, depicted at the top of FIG. 15, indicates where the requester is in the process. Work can be saved at many interim points in this process and finished later.

The requester develops most of the information contained in the request by employing check boxes, pull-down menus, and other techniques known in the art for the requester to select from lists of terms that are standard throughout the system or have been chosen by the receiver. In this way, the completed request can be readily classified by the receiver, and readily compared with other requests, since the use of common terminology and options for presentation and review of information facilitate classification and comparison.

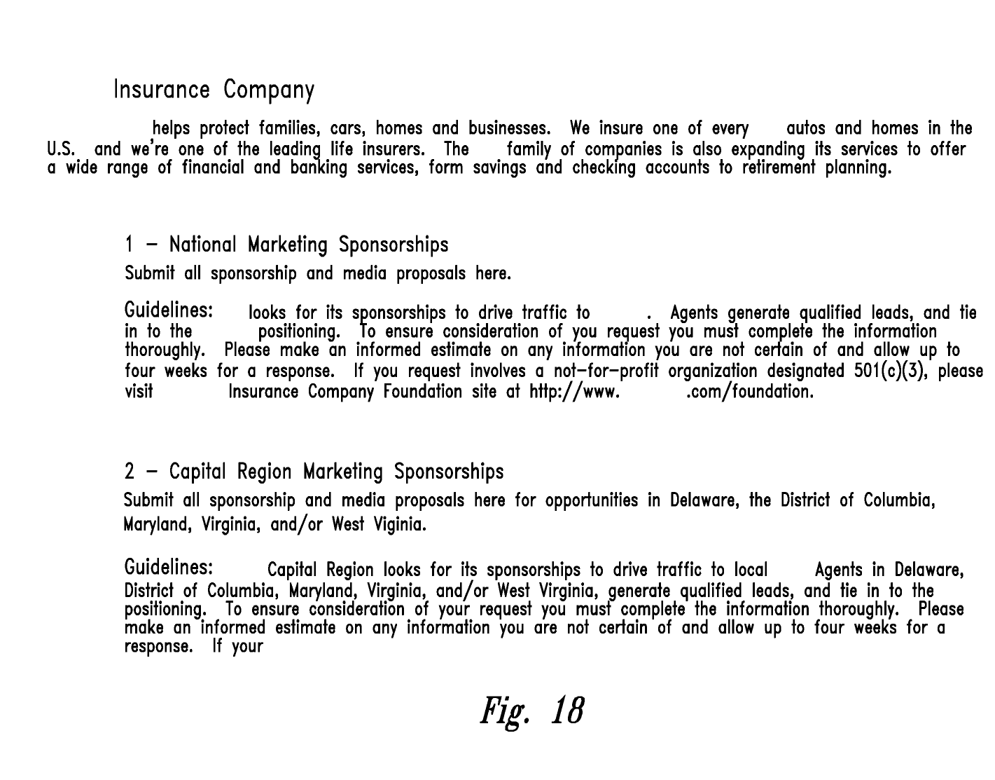

After the preparation of the request is complete, the system assists the requester in determining the appropriate mailbox to which the request is to be transmitted. The system assists the requester by providing a screen, as shown in FIG. 18, displaying textual information describing the function of the organization or department associated with each mailbox, by describing the types of requests that the organization or department associated with each mailbox is interested in receiving, or other guidelines specific to each mailbox developed by the receiver during system setup.

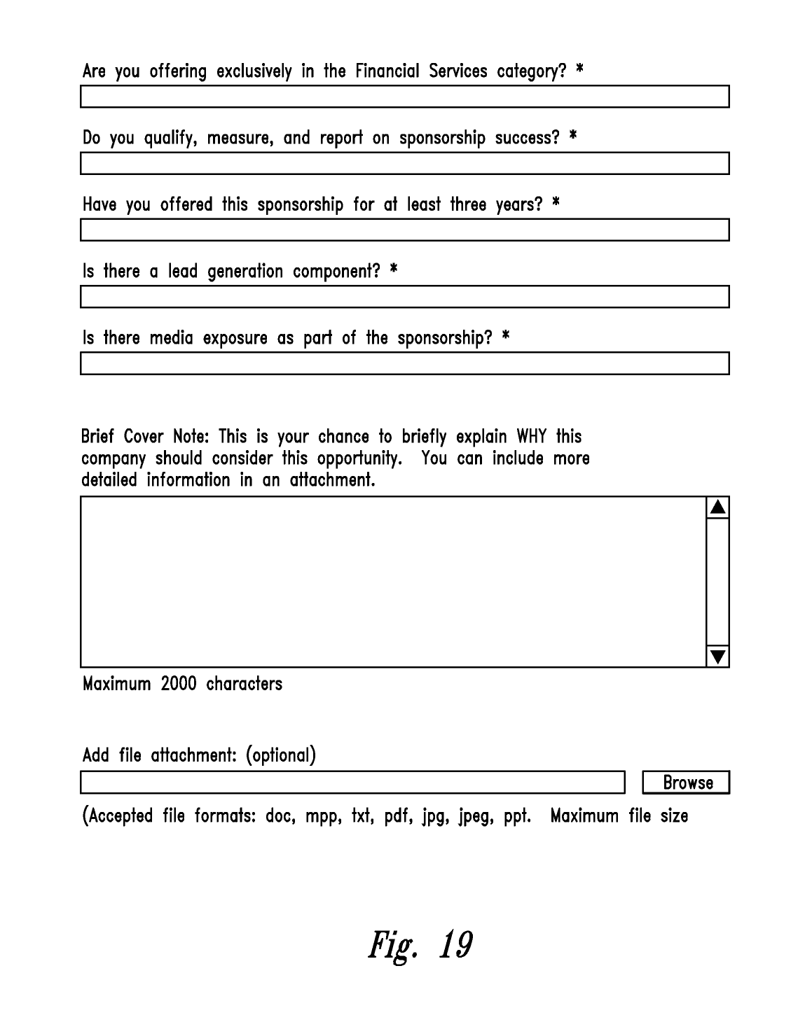

After the requester determines the appropriate mailbox, additional questions that are specific to the selected mailbox (which means, in this implementation, specific to an individual or department within the provider organization) can be presented via a screen in the web browser, as shown in FIG. 19. These questions, which are specific to a request type, are referred to as a “Survey.” This screen is also used by the requester to submit a cover letter, and optionally include a file of his or her choosing as an attachment. At the provider's request, more than one file may be attached. The file formats that may be attached can also be restricted.

The requester then employs the system to submit the request to the selected mailbox.

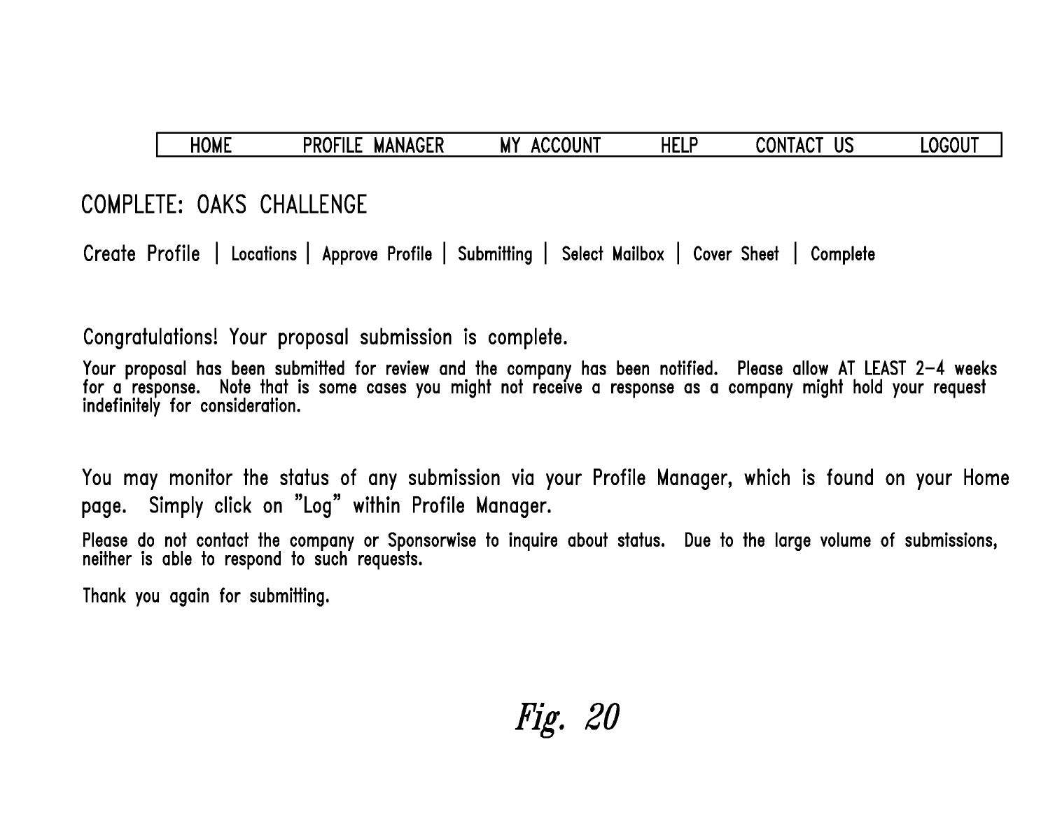

The system then provides a confirmation to the requester that the request has been received. An example of a confirmation screen is shown in FIG. 20. The online confirmation manages the requester's expectations, letting the requester know what to expect next.

After the request has been transmitted, a requester can see the status of the request, confirm submissions, and determine if the request has been forwarded or declined. This information is retrieved by the system from a log. The alternative values for the request status (which is viewable by both requesters and providers) include decline, sponsoring, archived, auto-declined, sponsoring, forwarded in, forwarded out, and imported from the database.

Requesters can also search the database for providers who may be receptive to a specific request. Using a capability called Sponsorwise Intelligence, when a requester creates a request, versions of the system can match the request template against the filters put in place by the providers who have selected to make their criteria known to the system. The system then can recommend specific providers whose criteria are best met by the request. Also, providers can be notified via email, or other method of alerting them, when proposals that closely meet their criteria are put into the database.

Features Supporting Providers

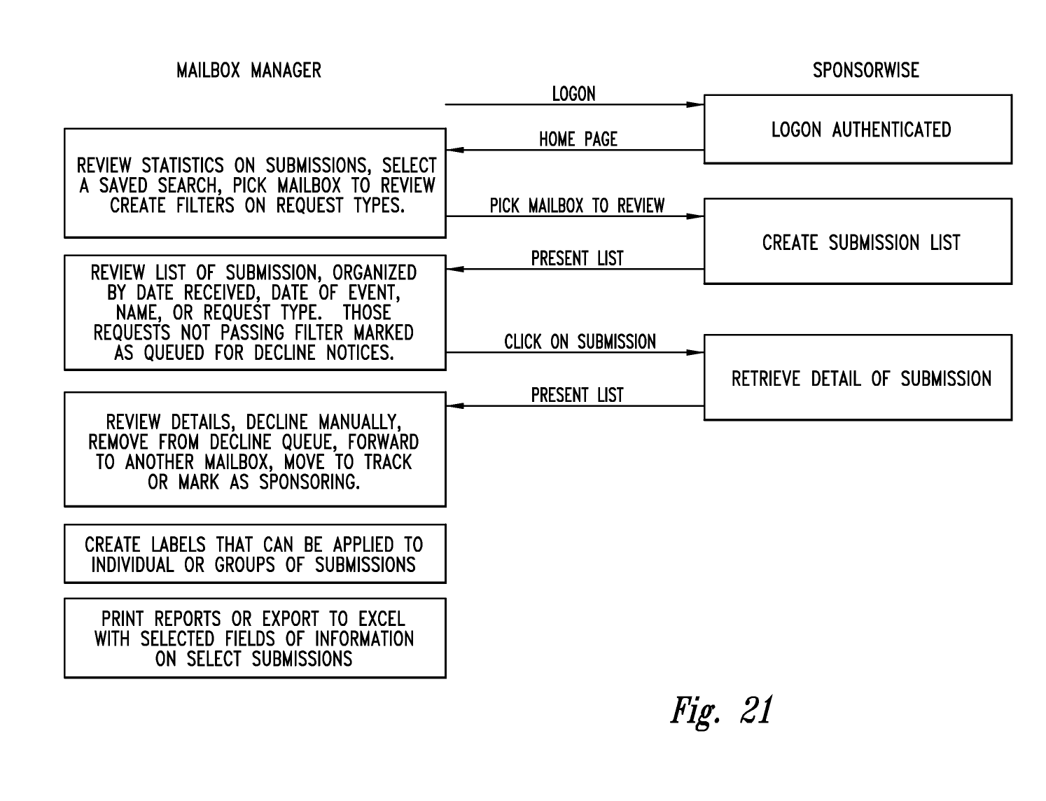

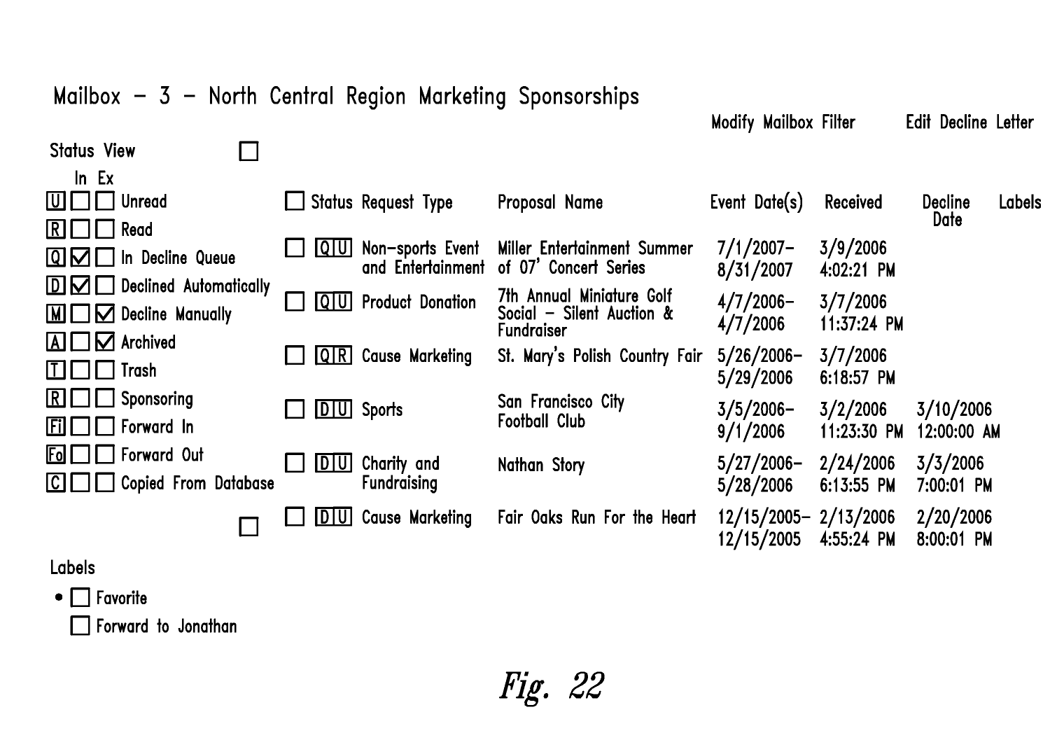

One individual is designated as the Mailbox Manager for each mailbox of the provider. The system supports the receipt, and management of the request, as well as the provider's decision process regarding the request, as discussed in the text below and depicted in FIG. 21. All requests that have been submitted to a particular mailbox can be viewed via a submission review page accessible to the provider, such as that shown in FIG. 22, displayed via the web browser. A list of status conditions and user-controlled labels is provided on the left side of the screen. The user checks or un-checks the status boxes on the left to specify which requests are listed and which are excluded.

To view a specific request, the user can mouse over its title and click.

Search results can be displayed that show the degree to which any particular request matches the totality of the search criteria. For example, if the request matches 3 of the 4 search criteria, then it will show a 75% match. The search results can be ordered by the degree of match.

The system uses a meta-data search engine that is self-describing, so that individuals associated with a provider can search the database of requests based on the answers to both the standard and provider-designed questions that are specific to a mailbox. In other words, creating a new survey/request template automatically creates a mechanism to search and filter that data for the provider to use. The Survey questions are used to automatically create new search terms. This greatly increases the speed with which a new or custom request type can be implemented within the system.

When a request has been received by an individual or organization associated with the receiver, the system can be employed to review it. Many requests can be filtered out, using the rules described above. These requests do not meet the criteria established by the requester during setup, and so can be automatically rejected. Versions of the system permit a provider to create and maintain a set of alphanumeric codes (“VIP Codes”) that they can give to requesters. Requests with these valid codes would not be automatically screened out, and are flagged for special handling. VIP codes enable executive managers of a provider let requesters know they will receive special treatment, permit requests associated with a particular event or source to be grouped together, and allow providers to implement custom decision processes using the standard Sponsorwise system.

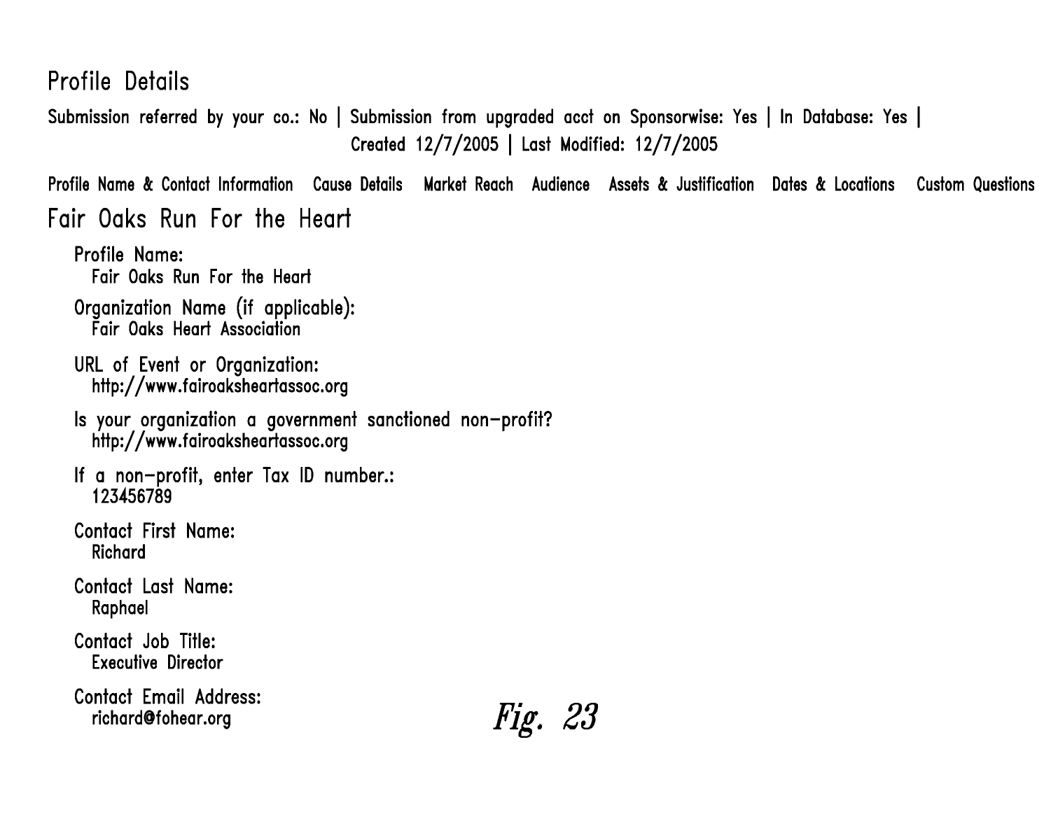

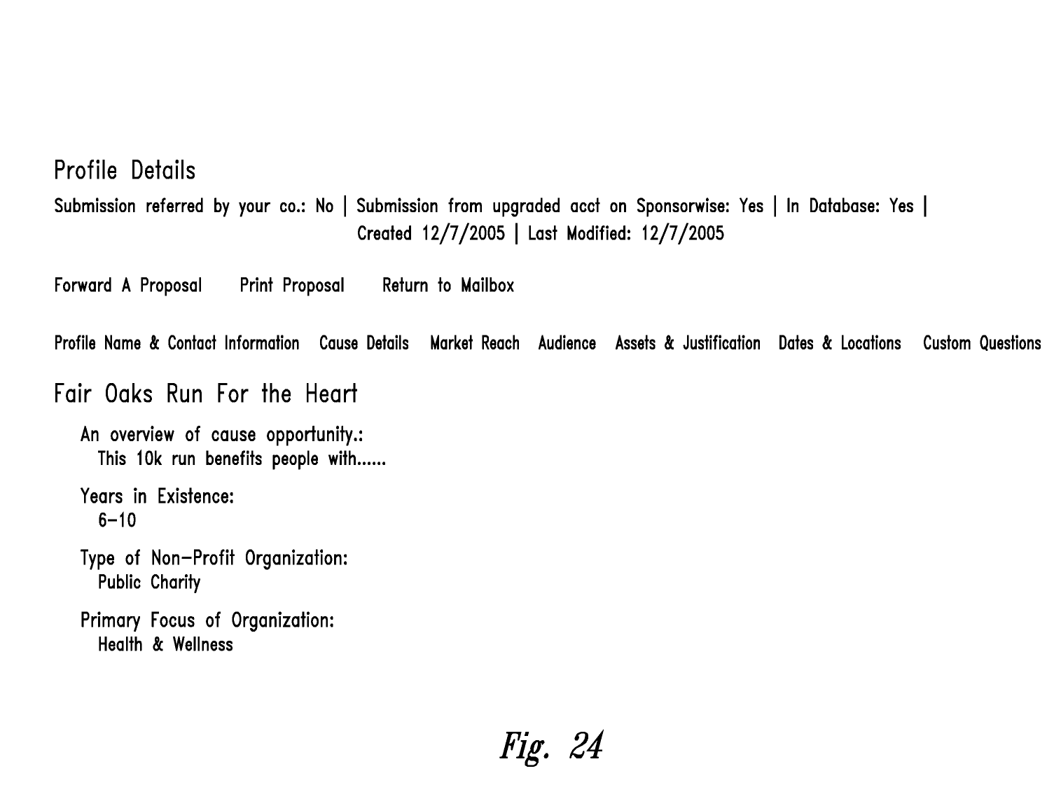

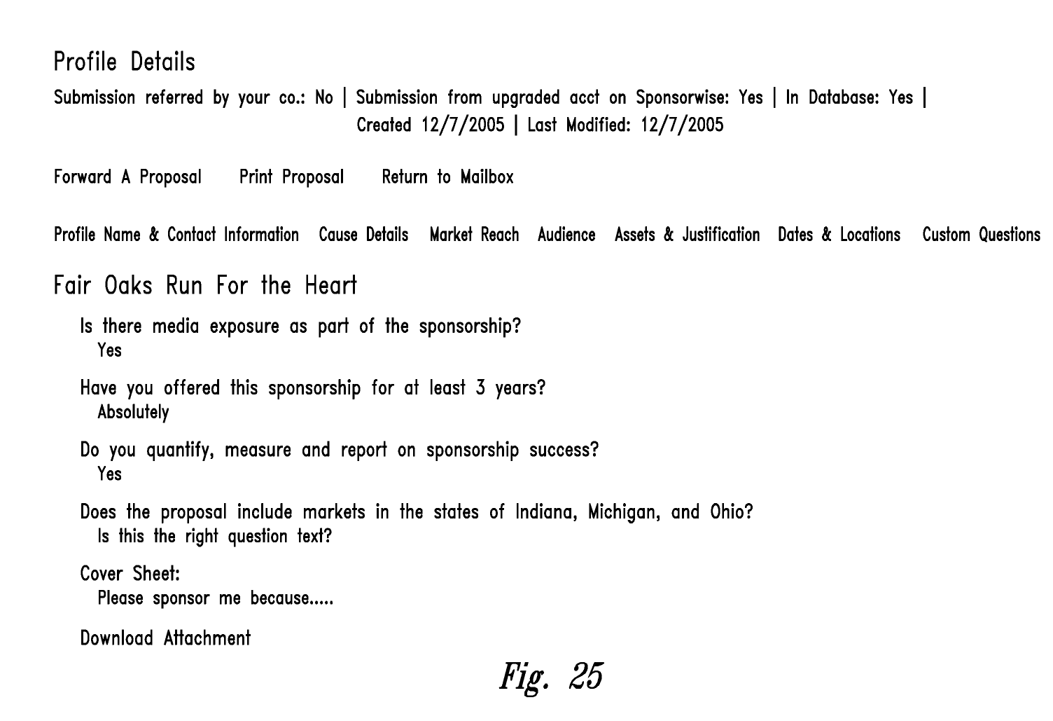

Whether or not the request has passed the filters, it can be reviewed by an individual associated with the mailbox that received it. This is done by displaying the information that the system gathered from the requester on the display screen of a web browser, as shown in FIGS. 23-25. FIG. 23 shows the information displayed when the user selects the “Profile Name and Contact Information” tab. FIG. 24 depicts the information displayed when the user selects the “Cause Details” tab. Information displayed when the user selects the “Custom Questions” tab is shown in FIG. 25.

The individual reviewing the request can see if a specific proposal is also in other mailboxes of the provider organization.

That individual can decide to gather further information about the request, forward it to another mailbox, or employ the system to assist in negotiating an agreement by searching on similar events and reviewing their pricing information. Alternatively, a message declining the request can be manually or automatically generated and then transmitted to the requester.

For requests that are filtered out, a rejection letter is prepared by the system, and is queued for transmission to the requester at a later time. The duration of this queuing is determined for each mailbox by the provider during setup. During the period when the rejection response is queued, the receiver can choose to override the automatic rejection and process the request as if the system had not rejected it. If the specified duration is reached without further action being taken, the rejection is emailed to the requester.

An individual associated with the provider organization can issue a standard rejection letter with a single click, or can customize the rejection for a specific request.

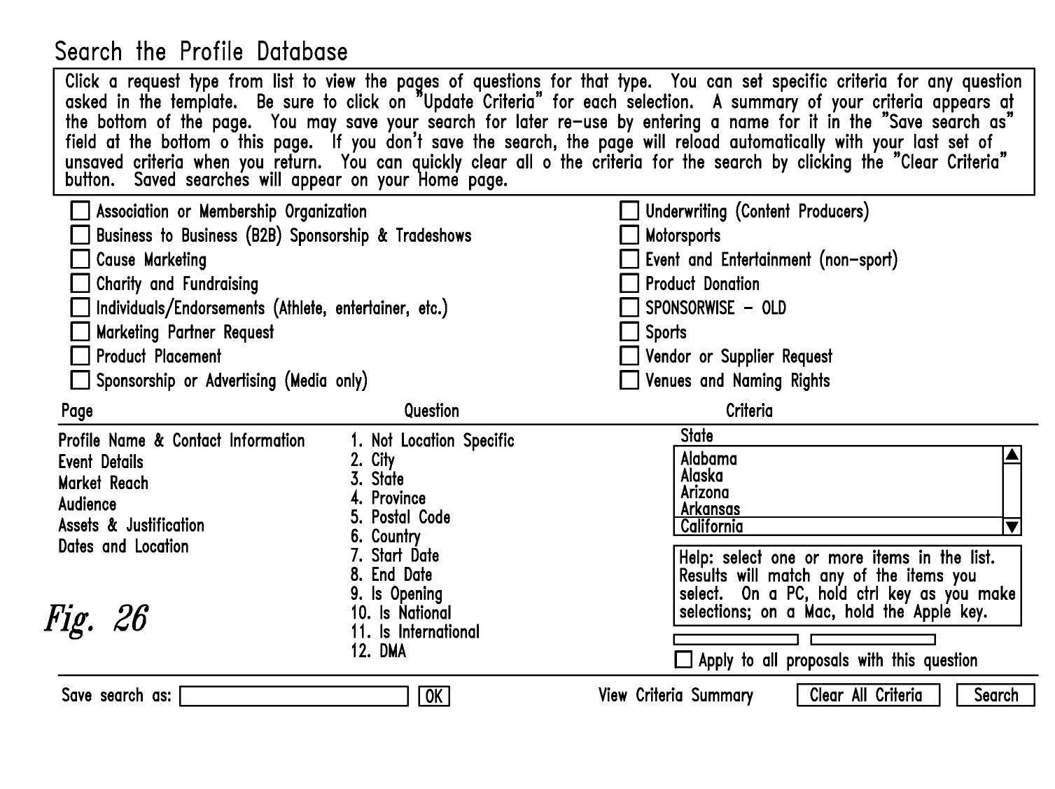

At any time, the provider can search the database of requests. The search can be restricted to a given mailbox, can span all the mailboxes of a provider, or can span the entire database. A simple search allows a provider to find proposals that match keywords within any or all of the Profile Name, Profile Summary or Organization Name. An advanced search allows a provider to search the entire database on virtually any information provided in the requester's profile. FIG. 26 shows the Advanced Search screen.

Providers seeking requests with particular characteristics are able to search the database for requests meeting their criteria, and request a proposal.

While the implementations described above address the management of sponsorships, it will be apparent to those skilled in the art that the methods and apparatus disclosed here are of high utility in many business situations in which a multiplicity of requesters for a type of resource interact with a multiplicity of providers of resources of that type. As examples, these include charity and fundraising, product donation, sports, motor sports, non-sport events and entertainment, cause marketing, venues and naming rights, individuals/endorsements (athlete, entertainer, etc.), sponsorship or advertising (media only), portfolio and rights management, underwriting (content producers), product placement, association or membership organization, business to business (B2B) sponsorship & tradeshows, marketing partner requests, and vendor or supplier requests.

Aspects of the Implementation

One aspect of the implementation is the ability for providers and the system itself to set statuses for proposals. For example, the status of “Read” is set automatically when the proposal is opened, as are the various “Declined” statuses when a request is denied as well as the status of those proposals forwarded in and out of the mailbox. But status such as “Sponsoring” is done manually.

Another aspect of the implementation is a set of tools for providers to create standard and custom reports that will help them communicate and analyze their requests. These reports can be printed and exported to other software programs using standard document formats such as tab-separated or comma-separated values. The provider can search the database and create a report with the fields they specify of each proposal that met the criteria for a given date range. Using the criteria for viewing in the mailbox view, the provider can create a report or export specified fields for the submissions in the mailbox view, including status and labels, for a given date range.

Another aspect of the implementation provides a weekly reminder email to corporations on the number of submissions they have had to their mailbox.

Another aspect of the implementation is an ability for providers to configure their system to meet their needs, including, for example, providing different questions for request types, or providing different values for entries in pull-down menus for answer selection.

In one or more various implementations, related systems include but are not limited to circuitry and/or programming for effecting the foregoing-referenced method implementations; the circuitry and/or programming can be virtually any combination of hardware, software, and/or firmware configured to effect the foregoing-referenced method implementations depending upon the design choices of the system designer.

The descriptions are summaries and thus contain, by necessity; simplifications, generalizations and omissions of detail; consequently, those skilled in the art will appreciate that the summaries are illustrative only and are not intended to be in any way limiting. Other aspects, inventive features, and advantages of the devices and/or processes described herein, as defined solely by the claims, will become apparent with respect to the non-limiting detailed description set forth herein.

Those having ordinary skill in the art will also appreciate that although only a number of server applications are shown, any number of server applications running on one or more server computer could be present (e.g., redundant and/or distributed systems could be maintained). Lastly, those having ordinary skill in the art will recognize that the environment depicted has been kept simple for sake of conceptual clarity, and hence is not intended to be limiting.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will appreciate that there are various vehicles by which processes and/or systems described herein can be effected (e.g., hardware, software, and/or firmware), and that the preferred vehicle will vary with the context in which the processes are deployed.

For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The detailed description has set forth various embodiments of the devices and/or processes via the use of block diagrams, flowcharts, and examples. Insofar as such block diagrams, flowcharts, and examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof.

From the foregoing it will be appreciated that, although specific embodiments of the invention have been described herein for purposes of illustration, various modifications may be made without deviating from the spirit and scope of the invention. Accordingly, the invention is not limited except as by the appended claims.

The invention claimed is

1. For a network having a plurality of websites and a plurality of computer stations, a submission center being networked with the computer stations, the submission center comprising:
a different one of a plurality of submission data structures for each one of the plurality of the websites, each submission data structure having a submission interface detail storage including a presentation style storage and an input requests storage.

2. The submission center of claim 1 further including a submission data structure generator configured to generate the submission data structures.

3. The submission center of claim 1 further including a submission engine configured to generate a web page for each of the submission data structures based at least in part on data stored in the presentation style storage and the input requests storage of the submission data structure, the web page to be transmitted to one of the computer stations.

4. The submission center of claim 1 wherein the submission data structure further includes a response rules storage,

5. The submission center of claim 4 further including a response generator configured to generate a message based in part upon rules contained in the response rules storage.

6. The submission center of claim 1 wherein each of the plurality of submission data structures includes a submission data storage configured to contain response data transmitted from one of the computer stations in response to receiving input requests based at least in part upon input request data stored in the input request storage of the submission data structure.

7. The submission center of claim 6 wherein each of the plurality of submission data structures includes a post-submission data storage configured to contain comment data associated with the response data.

8. The submission center of claim 1 wherein the submission data structure further includes a post-submission interface detail storage.

9. For a plurality of organizations and a plurality of computer stations, a submission center being networked with the computer stations, the submission center comprising:
a different one of a plurality of submission data structures for each one of the plurality of the organizations, each submission data structure having a submission interface detail storage including a presentation style storage and an input requests storage.

10. The submission center of claim 9 further including a submission data structure generator configured to generate the submission data structures.

11. The submission center of claim 9 further including a submission engine configured to generate a web page for each of the submission data structures based at least in part on data stored in the presentation style storage and the input requests storage of the submission data structure, the web page to be transmitted to one of the computer stations.

12. The submission center of claim 9 wherein the submission data structure further includes a response rules storage,

13. The submission center of claim 12 further including a response generator configured to generate a message based in part upon rules contained in the response rules storage.

14. The submission center of claim 9 wherein each of the plurality of submission data structures includes a submission data storage configured to contain response data transmitted from one of the computer stations in response to receiving input requests based at least in part upon input request data stored in the input request storage of the submission data structure.

15. The submission center of claim 14 wherein each of the plurality of submission data structures includes a post-submission data storage configured to contain comment data associated with the response data.

16. The submission center of claim 9 wherein the submission data structure further includes a post-submission interface detail storage.

17. For a submission center having submission data structures, the submission center being networked with computer stations on a network, the network having a plurality of websites, a method comprising:
receiving presentation style for a first of the plurality of websites;
receiving input requests for the first of the plurality of websites; and
generating a submission data structure for the first of the plurality of websites.

18. The method of claim 17 further including receiving access detail.

19. The method of claim 17 further including receiving response rules.

20. For a submission center having submission data structures, the submission center being networked with computer stations on a network, a method comprising:
receiving presentation style for a first of the plurality of organizations;
receiving input requests for the first of the plurality of websites; and
generating a submission data structure for the first of the plurality of websites.

21. The method of claim 20 further including receiving access detail.

22. The method of claim 20 further including receiving response rules.

23. For a submission center being networked with computer stations on a network, the network having a plurality of websites, a method comprising:
receiving an initiation from a first website, the first website having a first presentation style;
transmitting a first page of a first plurality of input requests designated to be used for the first website, the first page having the first presentation style and a first plurality of input requests;
receiving an initiation from a second website, the second website having a second presentation style; and
transmitting a second page of a first plurality of input requests designated to be used for the second website, the second page having the second presentation style and a second plurality of input requests.

24. The method of claim 23 further including
receiving first input for first plurality of input requests;
receiving search commands regarding the first input;
performing a search on the data including the first input based upon the received search commands; and
receiving comment data regarding the first input.

25. The method of claim 23 further including
receiving first submission data structure instructions; and
generating a first submission data structure based upon the received first submission data structure instructions, the first submission data structure including the first presentation style.
